(19) United States
(12) Patent Application Publication
(10) Pub. No.: US 2014/0044347 A1
(43) Pub. Date: Feb. 13, 2014

(54) MAGE CODING APPARATUS, IMAGE CODING METHOD, IMAGE CODING PROGRAM, IMAGE DECODING APPARATUS, IMAGE DECODING METHOD, AND IMAGE DECODING PROGRAM

(71) Applicant: Junsei Sato, Osaka-shi (JP)

(72) Inventor: Junsei Sato, Osaka-shi (JP)

(73) Assignee: SHARP KABUSHIKI KAISHA, Osaka-shi, Osaka (JP)

(21) Appl. No.: 14/113,282

(22) PCT Filed: Apr. 24, 2012
(86) PCT No.: PCT/JP2012/060972

§ 371 Date: Oct. 22, 2013

(30) Foreign Application Priority Data
Apr. 25, 2011 (JP) 2011-097176

(51) Int. Cl. G06T 9/00

(52) U.S. Cl. CPC G06T 9/004
USPC 382/154

(57) ABSTRACT

In an image coding apparatus that codes, on a block-by-block basis, a distance image including depth values each representing a pixel-by-pixel distance from a viewpoint to a subject, a segmentation unit divides a block of a texture image including luminance values of individual pixels of the subject into segments including the pixels on the basis of the luminance values, and an intra-plane prediction unit sets a depth value of each of the divided segments included in one block of the distance image on the basis of depth values of pixels included in an already-coded block adjacent to the block, and generates, on a block-by-block basis, a predicted image including the set depth values of the individual segments.

### TECHNICAL FIELD

The present invention relates to an image coding apparatus, an image coding method, an image coding program, an image decoding apparatus, an image decoding method, and an image decoding program.

This application claims priority of Patent Application No. 2011-097176 filed in Japan on Apr. 25, 2011, the entire contents of which are incorporated herein by reference.

### BACKGROUND ART

A method of using a texture image and a distance image for recording or transmitting/receiving the three-dimensional shape of a subject while performing image compression has been proposed. A texture image (a texture map; may also be referred to as a “reference image” a “plane image”, or a “color image”) is an image signal including signals that represent the color and density (may also be referred to as “luminance”) of a subject included in a subject space and of the background, and that are signals of individual pixels of an image arranged on a two-dimensional plane. A distance image (may also be referred to as a “depth map”) is an image signal including signal values (“depth values”) that correspond to distances from a viewpoint (such as an image capturing apparatus or the like) to individual pixels of the subject included in a three-dimensional subject space and background, and that are signal values of the individual pixels arranged on a two-dimensional plane. The pixels constituting the distance image correspond to the pixels constituting the texture image.

A distance image is used together with a corresponding texture image. Hitherto, in coding of the texture image, coding has been performed using an existing coding method (compression method) independent of the distance image. Meanwhile, in coding of the distance image, intra-plane prediction (intra-frame prediction) has been performed as in the case of the texture image, and coding has been performed independent of the texture image. For example, the method in NPL 1 includes a DC mode in which the average value of some pixel values in a block adjacent to a to-be-coded block serves as a predicted value, and a Plane mode in which a predicted value is set by interpolating a pixel value between these pixels.

### CITATION LIST

### Non Patent Literature

NPL 1: TELECOMMUNICATION STANDARIZATION SECTOR OF ITU, Intra prediction process, “ITU-T Recommendation H.264 Advanced video coding for generic audio visual services”, INTERNATIONAL TELECOMMUNICATION UNION, 2003. May, p. 100-110

### DISCLOSURE OF INVENTION

### Problems to be Solved by the Invention

However, since a distance image represents distances from a viewpoint to a subject, the range of a pixel group representing the same depth value is broader than the range of a pixel group representing the same luminance value in a texture image, and a change in depth value in a peripheral portion of that pixel group tends to be significant. Therefore, the coding method described in NPL 1 has a problem that the amount of information is not sufficiently compressed because correlation between adjacent blocks in the distance image cannot be utilized and prediction accuracy thus becomes inferior.

The present invention has been made in view of the above-described points, and an object thereof is to provide an image coding apparatus, an image coding method, an image coding program, an image decoding apparatus, an image decoding method, and an image decoding program for compressing the amount of information of a distance image, thereby solving the above-described problem.

### Means for Solving the Problems

The present invention has been made to solve the above-described problem, and an aspect of the present invention resides in an image coding apparatus that codes, on a block-by-block basis, a distance image including depth values each representing a pixel-by-pixel distance from a viewpoint to a subject, including: a segmentation unit that divides the block into segments on the basis of luminance values of individual pixels, and an intra-plane prediction unit that sets a representative value of depth values of each of the segments on the basis of depth values of pixels of an already-coded adjacent block.

(2) Another aspect of the present invention resides in the above-described image coding apparatus, wherein the intra-plane prediction unit sets, as a representative value of depth values of each of the segments, an average value of depth values of pixels of an adjacent block adjoining pixels included in the segment.

(3) Another aspect of the present invention resides in the above-described image coding apparatus, wherein the intra-plane prediction unit sets, as a representative value of depth values of each of the segments, an average value of depth values of pixels corresponding to the segment, among pixels of a block adjacent to a block including the segment.

(4) Another aspect of the present invention resides in the above-described image coding apparatus, wherein the intra-plane prediction unit sets, as a representative value of depth values of each of the segments, an average value of depth values of pixels adjoining a block boundary and corresponding to the segment, among pixels of a block adjacent to a block including the segment.

(5) Another aspect of the present invention resides in the above-described image coding apparatus, wherein the intra-plane prediction unit sets a representative value of depth values of each of the segments on the basis of depth values of pixels included in a block adjacent to the left of, and a block adjacent to the top of a block including the segment.

(6) Another aspect of the present invention resides in the above-described image coding apparatus, wherein the intra-plane prediction unit sets, as a representative value of depth values of each of the segments, an average value of depth values of pixels of left and upper adjacent blocks adjoining pixels included in the segment.

(7) Another aspect of the present invention resides in the above-described image coding apparatus, wherein the intra-plane prediction unit sets, as a representative value of depth values of each of the segments, an average value of depth values of pixels corresponding to the segment, among pixels of left and upper blocks adjacent to a block including the segment.

(8) Another aspect of the present invention resides in the above-described image coding apparatus, wherein the intra-plane prediction unit sets, as a representative value of depth values of each of the segments, an average value of depth values of pixels adjoining a block boundary and corresponding to the segment, among pixels of left and upper blocks adjacent to a block including the segment.

(9) Another aspect of the present invention resides in an image coding method of an image coding apparatus that codes, on a block-by-block basis, a distance image including depth values each representing a pixel-by-pixel distance from a viewpoint to a subject, including: a first process of dividing, in the image coding apparatus, the block into segments on the basis of luminance values of individual pixels; and a second process of setting, in the image coding apparatus, a representative value of depth values of each of the segments on the basis of depth values of pixels of an already-coded adjacent block.

(10) Another aspect of the present invention resides in an image coding program causing a computer included in an image coding apparatus that codes, on a block-by-block basis, a distance image including depth values each representing a pixel-by-pixel distance from a viewpoint to a subject to execute: the step of dividing the block into segments on the basis of luminance values of individual pixels; and the step of setting a representative value of depth values of each of the segments on the basis of depth values of pixels of an already-coded adjacent block.

(11) Another aspect of the present invention resides in an image decoding apparatus that decodes, on a block-by-block basis, a distance image including depth values each representing a pixel-by-pixel distance from a viewpoint to a subject, including: a segmentation unit that divides the block into segments on the basis of luminance values of individual pixels; and an intra-plane prediction unit that sets a representative value of depth values of each of the segments on the basis of depth values of pixels of an already-decoded adjacent block.

(12) Another aspect of the present invention resides in the above-described image decoding apparatus, wherein the intra-plane prediction unit sets, as a representative value of depth values of each of the segments, an average value of depth values of pixels of an adjacent block adjoining pixels included in the segment.

(13) Another aspect of the present invention resides in the above-described image decoding apparatus, wherein the intra-plane prediction unit sets, as a representative value of depth values of each of the segments, an average value of depth values of pixels corresponding to the segment, among pixels of a block adjacent to a block including the segment.

(14) Another aspect of the present invention resides in the above-described image decoding apparatus, wherein the intra-plane prediction unit sets, as a representative value of depth values of each of the segments, an average value of depth values of pixels adjoining a block boundary and corresponding to the segment, among pixels of a block adjacent to a block including the segment.

(15) Another aspect of the present invention resides in the above-described image decoding apparatus, wherein the intra-plane prediction unit sets a representative value of depth values of each of the segments on the basis of depth values of pixels included in a block adjacent to the left of, and a block adjacent to the top of a block including the segment.

(16) Another aspect of the present invention resides in the above-described image decoding apparatus, wherein the intra-plane prediction unit sets, as a representative value of depth values of each of the segments, an average value of depth values of pixels of left and upper adjacent blocks adjoining pixels included in the segment.

(17) Another aspect of the present invention resides in the above-described image decoding apparatus, wherein the intra-plane prediction unit sets, as a representative value of depth values of each of the segments, an average value of depth values of pixels corresponding to the segment, among pixels of left and upper blocks adjacent to a block including the segment.

(18) Another aspect of the present invention resides in the above-described image decoding apparatus, wherein the intra-plane prediction unit sets, as a representative value of depth values of each of the segments, an average value of depth values of pixels adjoining a block boundary and corresponding to the segment, among pixels of left and upper blocks adjacent to a block including the segment.

(19) Another aspect of the present invention resides in an image decoding method of an image decoding apparatus that decodes, on a block-by-block basis, a distance image including depth values each representing a pixel-by-pixel distance from a viewpoint to a subject, including: a first process of dividing, in the image decoding apparatus, the block into segments on the basis of luminance values of individual pixels; and a second process of setting, in the image decoding apparatus, a representative value of depth values of each of the segments on the basis of depth values of pixels of an already-decoded adjacent block.

(20) Another aspect of the present invention resides in an image decoding program causing a computer included in an image decoding apparatus that decodes, on a block-by-block basis, a distance image including depth values each representing a pixel-by-pixel distance from a viewpoint to a subject to execute: the step of dividing the block into segments on the basis of luminance values of individual pixels; and the step of setting a representative value of depth values of each of the segments on the basis of depth values of pixels of an already-decoded adjacent block.

### Effects of the Invention

According to the present invention, the amount of information of a distance image can be sufficiently compressed.

### BRIEF DESCRIPTION OF THE DRAWINGS

FIG. 1 is a schematic diagram illustrating a three-dimensional image capturing system according to an embodiment of the present invention.

FIG. 2 is a schematic diagram illustrating a coding apparatus according to the present embodiment.

FIG. 3 is a flowchart illustrating a process of dividing a block into segments, which is performed by a segmentation unit according to the present embodiment.

FIG. 4 is a conceptual diagram illustrating an example of adjacent segments according to the present embodiment.

FIG. 5 is a conceptual diagram illustrating an example of reference image blocks and a to-be-processed block according to the present embodiment.

FIG. 6 is a conceptual diagram illustrating another example of the reference image blocks and the to-be-processed block according to the present embodiment.

FIG. 7 is a conceptual diagram illustrating an example of a segment and pixel value candidates according to the present embodiment.

FIG. 8 is a conceptual diagram illustrating another example of the segment and the pixel value candidates according to the present embodiment.

FIG. 9 is a flowchart illustrating an image coding process performed by the image coding apparatus according to the present embodiment.

FIG. 10 is a schematic diagram illustrating the configuration of an image decoding apparatus according to the present embodiment.

FIG. 11 is a flowchart illustrating an image decoding process performed by the image decoding apparatus according to the present embodiment.

### BEST MODE FOR CARRYING OUT THE INVENTION

Hereinafter, an embodiment of the present invention will be described with reference to the drawings.

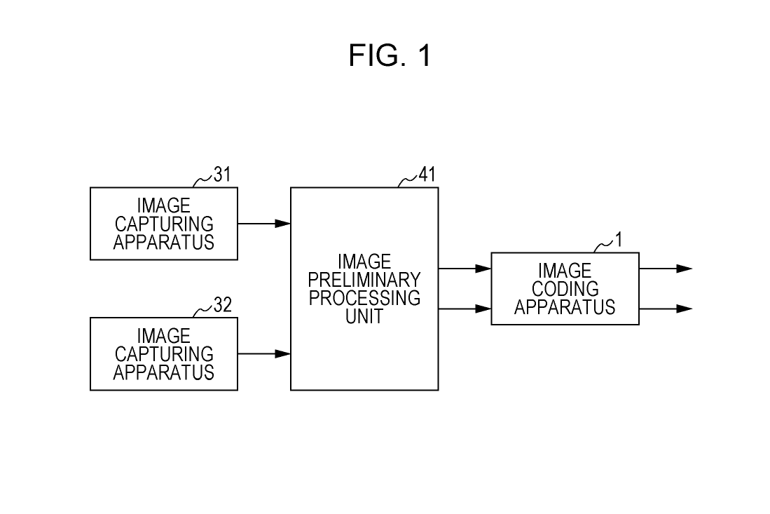

FIG. 1 is a schematic diagram illustrating a three-dimensional image capturing system according to the embodiment of the present invention. The image capturing system includes an image capturing apparatus 31, an image capturing apparatus 32, an image preliminary processing unit 41, and an image coding apparatus 1.

The image capturing apparatus 31 and the image capturing apparatus 32 are located at positions (viewpoints) different from each other, and capture images of a subject included in the same perspective at predetermined time intervals. The image capturing apparatus 31 and the image capturing apparatus 32 output the captured images to the image preliminary processing unit 41.

The image preliminary processing unit 41 sets an image input from one of the image capturing apparatus 31 and the image capturing apparatus 32, such as from the image capturing apparatus 31, as a texture image. The image preliminary processing unit 41 generates a distance image by calculating disparity between the texture image and the image input from the other image capturing apparatus 32 on a pixel-by-pixel basis. In the distance image, a depth value representing the distance from the viewpoint to the subject is set for each pixel. For example, International Standard MPEG-C part 3, defined by MPEG (Moving Picture Experts Group), which is a working group of International Organization for Standardization/International Electrotechnical Commission (ISO/IEC), defines to represent a depth value with 8 bits (256 layers). That is, the distance image represents shades by using the depth value of each pixel. Also, the closer the distance from the viewpoint to the subject is, the greater the depth value becomes. Thus, a (brighter) image with a higher luminance is constituted.

The image preliminary processing unit 41 outputs the texture image and the generated distance image to the image coding apparatus 1.

Note that, in the present embodiment, the number of image capturing apparatuses included in the image capturing system is not limited to two; the number may be three or more. Also, the texture image and the distance image input to the image coding apparatus 1 may not necessarily be based on images captured by the image capturing apparatus 31 and the image capturing apparatus 32, and may be pre-synthesized images.

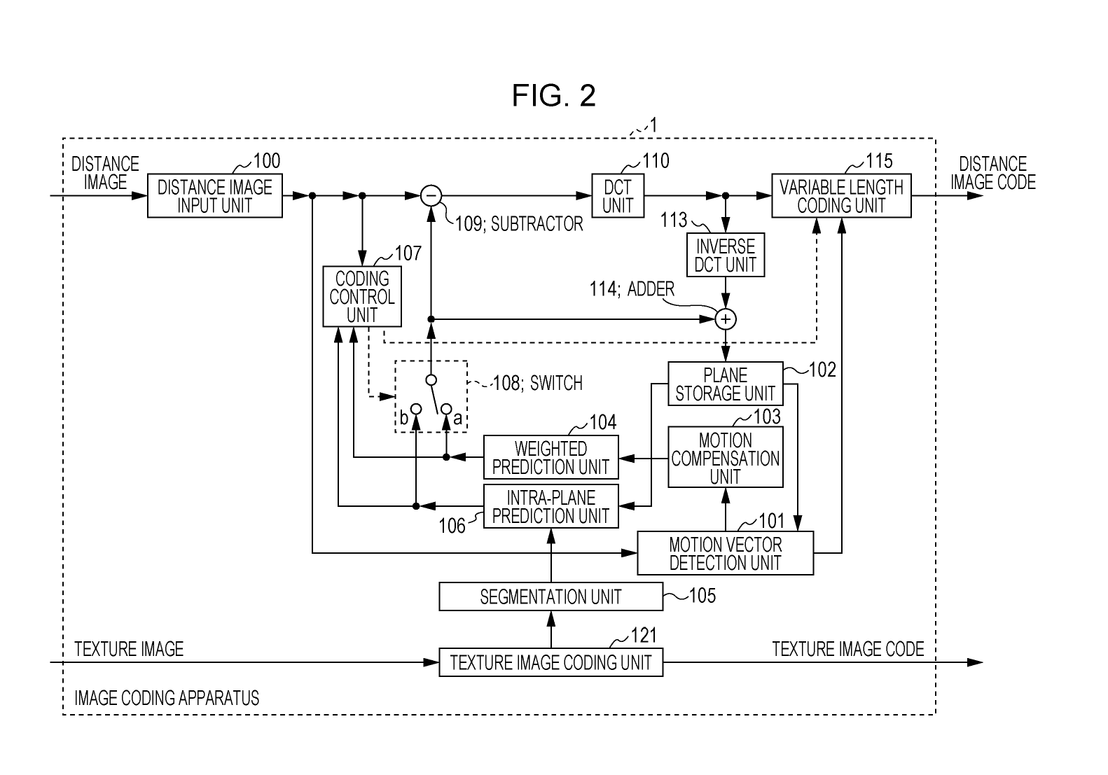

FIG. 2 is a schematic block diagram of the image coding apparatus 1 according to the present embodiment.

The image coding apparatus 1 includes a distance image input unit 100, a motion vector detection unit 101, a plane storage unit 102, a motion compensation unit 103, a weighted prediction unit 104, a segmentation unit 105, an intra-plane prediction unit 106, a coding control unit 107, a switch 108, a subtractor 109, a DCT unit 110, an inverse DCT unit 113, an adder 114, a variable length coding unit 115, and a texture image coding unit 121.

The distance image input unit 100 receives, as an input, a distance image on a frame-by-frame basis from the outside of the image coding apparatus 1, and extracts a block (referred to as a “distance image block”) from the input distance image. Here, pixels constituting the distance image correspond to pixels constituting a texture image input to the texture image coding unit 121. The distance image input unit 100 outputs the extracted distance image block to the motion vector detection unit 101, the coding control unit 107, and the subtractor 109.

The distance image block consists of a predetermined number of pixels (such as 16 pixels in the horizontal direction×16 pixels in the vertical direction).

The distance image input unit 100 shifts the position of a block for extracting a distance image block in the order of raster scan so that individual blocks do not overlap one another. That is, the distance image input unit 100 sequentially moves, to the right, a block for extracting a distance image block by the number of pixels in the horizontal direction of the block, starting with the upper left-hand corner of the frame. After the right end of a block for extracting a distance image block reaches the right end of the frame, the distance image input unit 100 moves that block downward by the number of pixels in the vertical direction of the block, to the left end of the frame. In this manner, the distance image input unit 100 moves a block for extracting a distance image block until the block reaches the lower right-hand corner of the frame.

The motion vector detection unit 101 receives, as an input, the distance image block from the distance image input unit 100, and reads a block constituting a reference image (reference image block) from the plane storage unit 102.

The reference image block consists of the same number of pixels in the horizontal direction and the vertical direction as the distance image block. The motion vector detection unit 101 detects the difference between the coordinates of the input distance image block and the coordinates of the reference image block as a motion vector. To detect a motion vector, the motion vector detection unit 101 can use, for example, an available method described in the ITU-T H.264 standard. Hereinafter, this point will be described.

The motion vector detection unit 101 moves a position for reading a reference image block from a frame of the reference image stored in the plane storage unit 102 one pixel at a time in the horizontal direction or the vertical direction within a preset range from the position of the distance image block. The motion vector detection unit 101 calculates an index value indicating similarity or correlation between the signal value of each pixel included in the distance image block and the signal of each pixel included in the read reference image block, such as the SAD (Sum of Absolute Differences). There is a relation that, the smaller the value of SAD, the more similar the signal value of each pixel included in the distance image block and the signal of each pixel included in the read reference image block. Therefore, the motion vector detection unit 101 sets a preset number of (such as two) reference image blocks with the minimum SAD as reference image blocks corresponding to the extracted distance image block. The motion vector detection unit 101 calculates a motion vector on the basis of the coordinates of the input distance image block and the coordinates of the reference image blocks.

The motion vector detection unit 101 outputs a motion vector signal indicating the motion vector calculated for each block to the variable length coding unit 115, and outputs the read reference image blocks to the motion compensation unit 103.

The plane storage unit 102 arranges and stores reference image blocks input from the adder 114 at the block positions in a corresponding frame. An image signal of a frame constituted by arranging reference image blocks in this manner is a reference image. Note that the plane storage unit 102 deletes reference images of past frames, the number of which is a preset number (such as 6).

The motion compensation unit 103 sets the positions of the reference image blocks input from the motion vector detection unit 101 as the positions of respectively input distance image blocks. Accordingly, the motion compensation unit 103 can compensate for the positions of the reference image blocks on the basis of the motion vector detected by the motion vector detection unit 101. The motion compensation unit 103 outputs the reference image blocks whose positions have been set to the weighted prediction unit 104.

The weighted prediction unit 104 generates a weighted-predicted image block by multiplying each of the reference image blocks, input from the motion compensation unit 103, by a weight coefficient, and adding these reference image blocks. The weight coefficient may be a preset weight coefficient, or may be a pattern selected from among patterns of weight coefficients stored in advance in a code book. The weighted prediction unit 104 outputs the generated weighted-predicted image block to the coding control unit 107 and the switch 108.

The texture image is input to the texture image coding unit 121. The segmentation unit 105 receives, as an input, a decoded texture image block from the texture image coding unit 121. Note that the decoded texture image block constitutes a texture image that has been decoded to represent the original texture image. The decoded texture image block input to the segmentation unit 105 corresponds to, on a pixel-by-pixel basis, the distance image block output by the distance image input unit 100. The segmentation unit 105 divides the decoded texture image block into segments which are a group of one or more pixels on the basis of the luminance values of individual pixels included in the decoded texture image block.

The segmentation unit 105 outputs, to the intra-plane prediction unit 106, segment information indicating a segment to which pixels included in each block belong.

The reason the segmentation unit 105 does not divide the original texture image into segments but divides the decoded texture image block into segments is to optimize the coding quality only using information that can be obtained even on the decoding side.

Next, a process of dividing, by the segmentation unit 105, one block into segments (may also be referred to as “segmentation”) will be described.

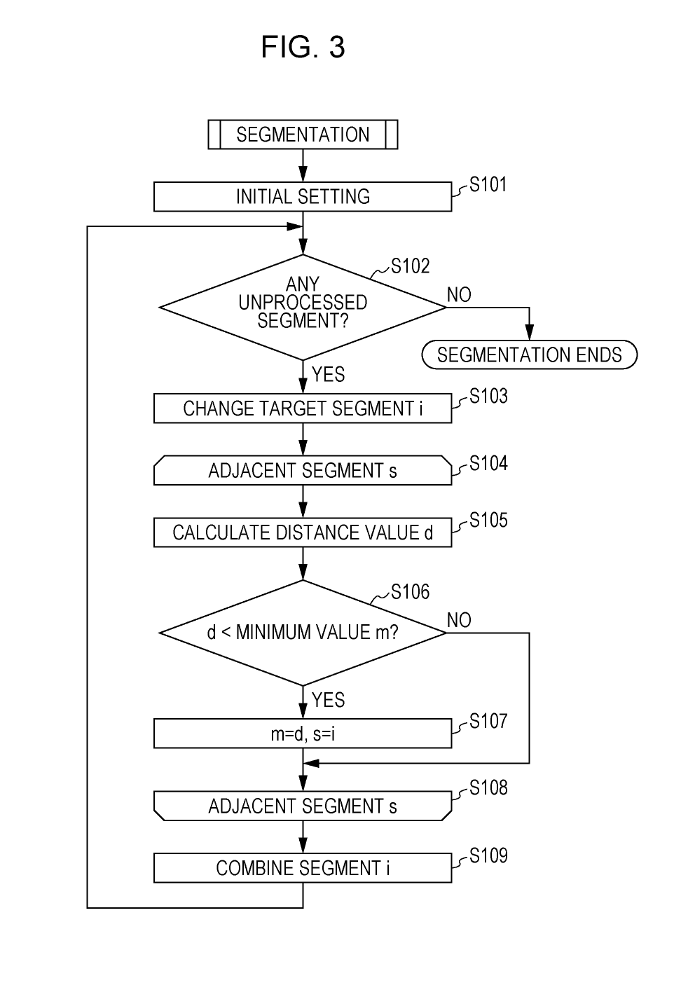

FIG. 3 is a flowchart illustrating a process of dividing a block into segments according to the present embodiment.

(step S101) The segmentation unit 105 initially sets, for each of pixels constituting a block, the number (segment number) i of a segment to which that pixel belongs as the coordinate of the pixel, and a processing flag indicating the presence/absence of processing to 0 (zero; a value indicating that processing has not been done). Also, the segmentation unit 105 initially sets the minimum value m of an inter-representative-value distance d of each segment described later. Thereafter, the segmentation unit 105 proceeds to step S102.

In the case where the decoded texture image is, for example, an RGB signal represented using a signal R indicating the luminance value of red, a signal G indicating the luminance value of green, and a signal B indicating the luminance value of blue, a color space vector (R, G, B) which is a set of the signal values R, G, and B represents a color space of each pixel. Note that, in the present embodiment, the decoded texture image is not limited to an RGB signal and may be a signal based on another colorimetric system, such as an HSV signal, a Lab signal, or a YCbCr signal.

(step S102) The segmentation unit 105 determines the presence/absence of an unprocessed segment by referring to the processing flag of that block. In the case where the segmentation unit 105 determines that there is an unprocessed segment (step S102 Y), the segmentation unit 105 proceeds to step S103. In the case where the segmentation unit 105 determines that there is no unprocessed segment (step S102 N), the segmentation unit 105 ends the segmentation process.

(step S103) The segmentation unit 105 changes the to-be-processed segment i to any of unprocessed segments. When changing the to-be-processed segment, the segmentation unit 105 changes the to-be-processed segment in the order of, for example, raster scan. In this order, the segmentation unit 105 regards the pixel in the upper right-hand corner of the previously processed segment as a reference pixel, and regards an unprocessed segment adjacent to the right of the reference pixel as a to-be-processed target. In the case where there is no to-be-processed segment, the segmentation unit 105 sequentially moves the reference pixel to the right, one pixel at a time, until a to-be-processed segment is found. In the case where no to-be-processed segment is found even when the reference pixel reaches the rightmost pixel of the block, the segmentation unit 105 moves the reference pixel to a pixel one pixel below the left end of the block. In this manner, the segmentation unit 105 repeats the process of moving the reference pixel until a to-be-processed segment is found.

Note that, in the initial state where no processed segment exists, the segmentation unit 105 sets the pixel in the upper left-hand corner of the block as a to-be-processed segment. Thereafter, the segmentation unit 105 proceeds to step S104.

(step S104) The segmentation unit 105 repeats the following steps S105 to S108 for each adjacent segment s adjoining the to-be-processed segment i.

(step S105) The segmentation unit 105 calculates the distance value d between the representative value of the to-be-processed segment i and the representative value of the adjacent segment s. The representative value of each segment may be an average value of the color space vector of each pixel included in the segment, or a color space vector of one pixel included in that segment (for example, the pixel in the uppermost left-hand corner of the segment or the pixel at or closest to the barycenter of the segment). In the case where there is only one pixel included in the segment, a color space vector of that pixel is the representative value.

The distance value d is an index value indicating the degree of similarity between the representative value of the to-be-processed segment i and the representative value of the adjacent segment s, such as Euclidean distance. In the present embodiment, the distance value d may be any of city block distance, Minkowski distance, Chebyshev distance, and Mahalanobis distance, besides Euclidean distance. Thereafter, the segmentation unit 105 proceeds to step S106.

(step S106) The segmentation unit 105 determines whether the distance value d is smaller than the minimum value m. In the case where the segmentation unit 105 determines that the distance value d is smaller than the minimum value m (step S106 Y), the segmentation unit 105 proceeds to step S107. In the case where the segmentation unit 105 determines that the distance value d is equal to the minimum value m or greater than the minimum value m (step S106 N), the segmentation unit 105 proceeds to step S108.

(step S107) The segmentation unit 105 determines that the adjacent segment s belongs to the target segment i. That is, the segmentation unit 105 concludes the adjacent segment s as the target segment i. In addition, the segmentation unit 105 replaces the minimum value m with the distance d. Thereafter, the segmentation unit 105 proceeds to step S108.

(step S108) The segmentation unit 105 changes the adjacent segment s adjoining the target segment i. In a process of changing the adjacent segment s, the segmentation unit 105 may perform the same or similar processing as in the case of changing the to-be-processed segment i in step S103. Note that, in the present embodiment, the adjacent segment s refers to a segment that includes a pixel that has one of the coordinates in the vertical direction and the horizontal direction being equal to a pixel included in the target segment i and the other coordinate being different by one pixel.

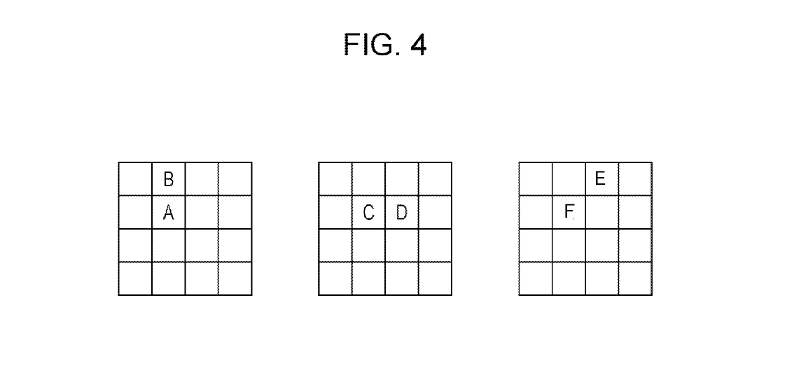

FIG. 4 is a conceptual diagram illustrating an example of adjacent segments according to the present embodiment.

The left diagram, the center diagram, and the right diagram in FIG. 4 illustrate, for example, blocks consisting of 4 pixels in the horizontal direction×4 pixels in the vertical direction. In the left diagram in FIG. 4, the segmentation unit 105 determines that a pixel B on the uppermost row, second column from the left and a pixel A on the second row from the top, second column from the left are adjacent to each other. In the center diagram in FIG. 3, the segmentation unit 105 determines that a pixel C on the second row from the top, second column from the left and a pixel D on the second row from the top, third column from the left are adjacent to each other. In the right diagram in FIG. 3, the segmentation unit 105 determines that a pixel E on the uppermost row, third column from the left and a pixel F on the second row from the top, second column from the left are not adjacent to each other. That is, the segmentation unit 105 determines that pixels that sandwich at least one side are adjacent to each other.

Referring back to FIG. 3, in the case where the segmentation unit 105 discovers another adjacent segment, the segmentation unit 105 regards that the discovered adjacent segment as a new adjacent segment, and returns to step S105. In the case where the segmentation unit 105 cannot discover another adjacent segment, the segmentation unit 105 proceeds to step S109.

(step S109) In the case where there is an adjacent segment that is newly determined as the target segment i, the segmentation unit 105 combines (may also be referred to as “merges”) the target segment i and the adjacent segment which is newly determined as the target segment i. That is, the segmentation unit 105 regards, as the target segment i, a segment to which each of pixels included in the adjacent segment determined as the target segment i belongs. In addition, the segmentation unit 105 sets the representative value of the combined target segment i on the basis of the method described in step S105. Information indicating a segment to which each pixel belongs constitutes the previously-mentioned segment information. Also, the segmentation unit 105 sets the processing flags of pixels belonging to the target segment i as 1 (indicating that processing has been done). Thereafter, the segmentation unit 105 proceeds to step S102.

Note that, for one reference image block, the segmentation unit 105 may enlarge the size of each segment by executing the segmentation process illustrated in FIG. 2 not only once, but also multiple times.

Alternatively, in step S106 in FIG. 3, the segmentation unit 105 may further determine whether the distance value d is smaller than a preset distance threshold T, and, in the case where the distance value d is smaller than the minimum value m and the distance value d is smaller than the preset distance threshold T (step S106 Y), the segmentation unit 105 may proceed to step S107. In addition, in the case where the segmentation unit 105 determines that the distance value d is equal to the minimum value m or greater than the minimum value d, or the distance d is equal to the present distance threshold T or greater than the threshold T (step S106 N), the segmentation unit 105 may proceed to step S108.

In this manner, as long as the distance between the representative value of the adjacent segment s and the representative value of the target segment i is within a certain value range, the segmentation unit 105 can combine the adjacent segment s with the target segment i.

Note that, in step S107 in FIG. 3, the segmentation unit 105 may perform a process of combining the adjacent segment s, which is determined to belong to the target segment i, with the target segment i described in step S109. In that case, the segmentation unit 105 does not change the representative value of the target segment i though the target segment i is combined with the adjacent segment s, and, in step S106, performs determination by additionally using the above-described threshold T. Accordingly, the segmentation unit 105 can combine segments without repeating the segmentation process illustrated in FIG. 3.

Referring back to FIG. 2, the intra-plane prediction unit 106 receives, as an input, the segment information of each block from the segmentation unit 105, and reads reference image blocks from the plane storage unit 102. The reference image blocks read by the intra-plane prediction unit 106 are already coded blocks and are blocks constituting a reference image of a frame serving as a current processing target. For example, the reference image blocks read by the intra-plane prediction unit 106 include a reference image block adjacent to the left of, and a reference image block adjacent to the top of a block serving as a current processing target.

On the basis of the input segment information and the read reference image blocks, the intra-plane prediction unit 106 performs intra-plane prediction and generates an intra-plane-predicted image block. Firstly, the intra-plane prediction unit 106 sets, as the pixel value candidates (depth values) of pixels of the to-be-processed block that are adjacent to (or predetermined and close to) a reference image block, the signal values (depth values) of pixels (preferably closest to the to-be-processed block) included in the adjacent reference image block.

Here, a process of setting, by the intra-plane prediction unit 106, pixel candidates in the present embodiment will be described.

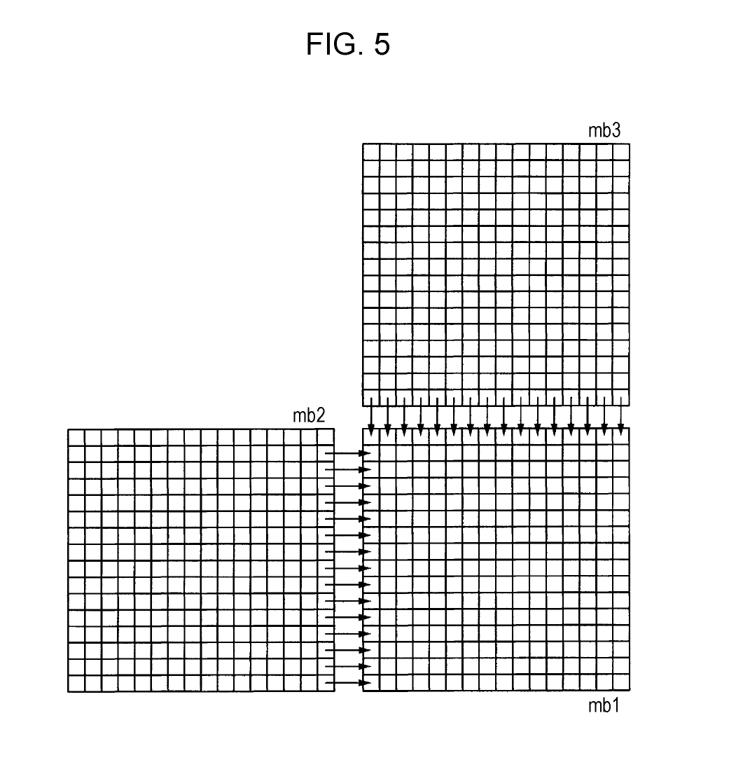

FIG. 5 is a conceptual diagram illustrating an example of reference image blocks and a to-be-processed block according to the present embodiment.

In FIG. 5, a block mb1 on the right side of the lower row indicates a to-be-processed block, and a block mb2 on the left side of the lower row and a block mb3 on the upper row indicate reference image blocks that have been read.

Arrows from the individual pixels of the lowermost row of the block mb3 in FIG. 5 to the pixels of corresponding columns of the uppermost row of the block mb1 indicate that the intra-plane prediction unit 106 sets the depth values of the individual pixels of the uppermost row of the block mb1 to the depth values of the corresponding pixels of the lowermost row of the block mb3. Arrows from the individual pixels of the second row from the top to the lowermost row of the rightmost column of the block mb2 in FIG. 5 to the pixels of the corresponding rows of the leftmost column of the block mb1 indicate that the intra-plane prediction unit 106 sets the depth values of the individual pixels of the leftmost column of the block mb1 to the depth values of the corresponding pixels of the rightmost column of the block mb2.

Note that it may be set that the depth value of the pixel in the upper left-hand corner of the block mb1 is the depth value of the pixel in the upper right-hand corner of the block mb2.

When setting pixel value candidates, the intra-plane prediction unit 106 may use the depth values of pixels included in, besides the reference image block adjacent to the left of the to-be-processed block and the reference image block adjacent to the top of the to-be-processed block, a reference image block adjacent and at the upper right of the to-be-processed block.

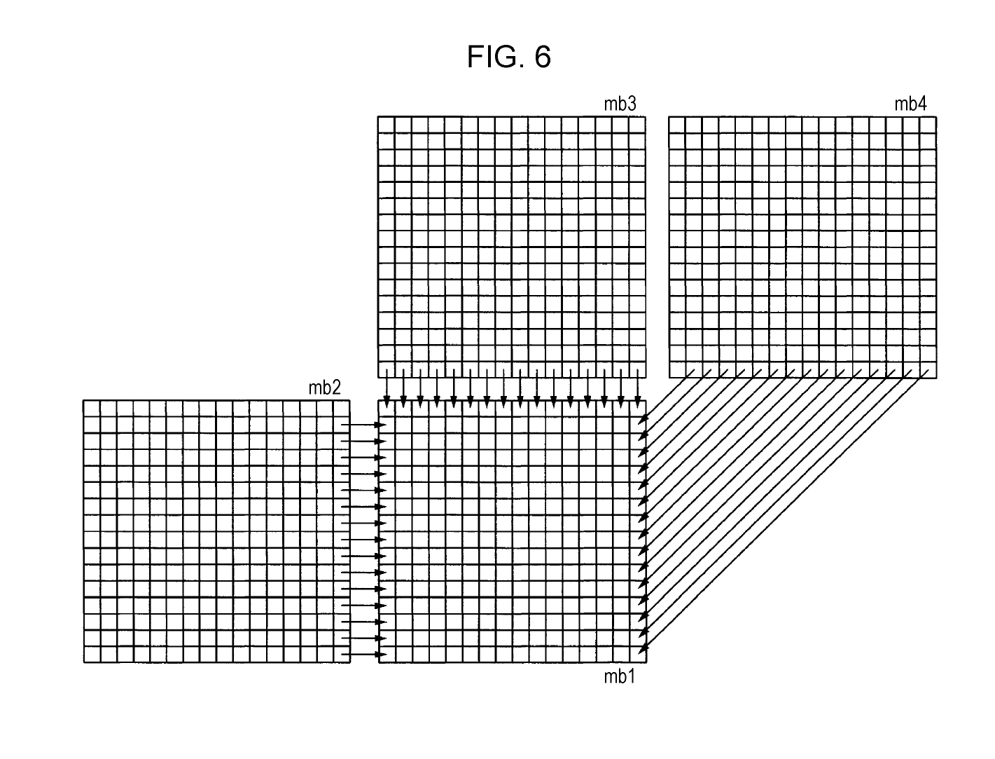

FIG. 6 is a conceptual diagram illustrating another example of the reference image blocks and the to-be-processed block according to the present embodiment.

In FIG. 6, the blocks mb1, mb2, and mb3 are the same as FIG. 5. A block mb4 on the right side of the upper row in FIG. 6 indicates a reference image block that has been read. Arrows from the individual pixels of the lowermost row, the second column to the rightmost column of the block mb4 in FIG. 6 to, as the corresponding pixels, the individual pixels of the rightmost column, the second row to the lowermost row of the block mb1 indicate that the intra-plane prediction unit 106 sets the depth values of the individual pixels of the rightmost column, the second row to the lowermost row of the block mb1 to the depth values of the individual pixels of the lowermost row, the second column to the rightmost column of mb4.

Next, in the case where a segment indicating the input segment information includes pixel value candidates, the intra-plane prediction unit 106 sets the representative value of the segment on the basis of the pixel value candidates.

For example, the intra-plane prediction unit 106 may set the average value of the pixel value candidates included in a certain segment as the representative value, or may set the pixel value candidate of one pixel included in that segment as the representative value. In the case where a certain segment includes the same pixel value candidates, the intra-plane prediction unit 106 may set a pixel value candidate whose number of pixels is the largest as the representative value of the segment.

The intra-plane prediction unit 106 sets the depth value of each pixel included in the segment to the set representative value.

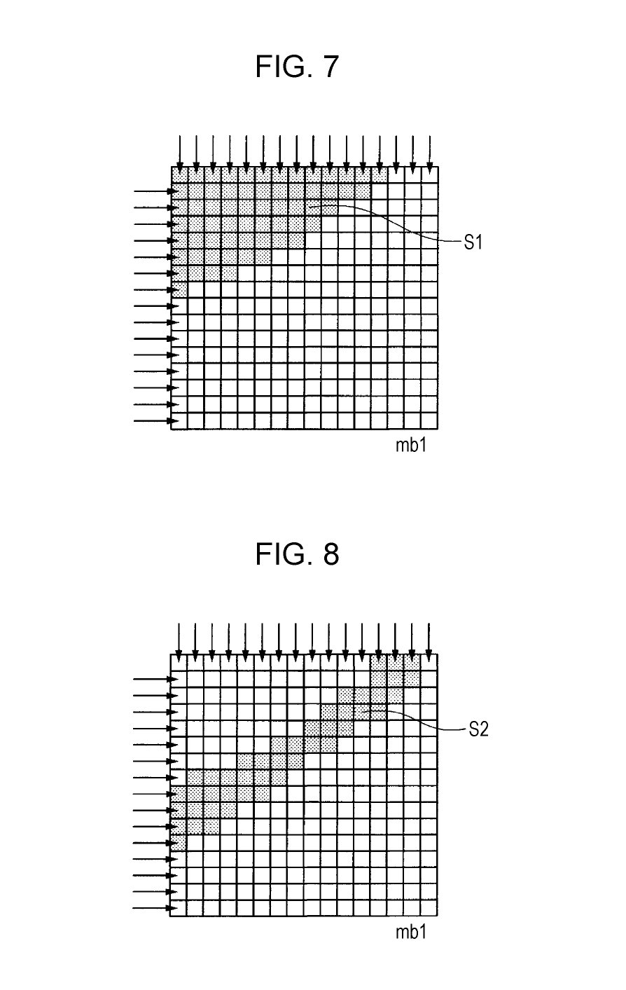

FIG. 7 is a conceptual diagram illustrating an example of a segment and pixel value candidates according to the present embodiment.

In FIG. 7, the block mb1 indicates a to-be-processed block. Pixels in a shaded portion in the upper left-hand corner of the block mb1 indicate a segment S1. Arrows directed to the individual pixels of the leftmost column and the uppermost row of the block mb1 indicate that pixel value candidates for these pixels have been set. Here, the intra-plane prediction unit 106 sets the representative value of the segment S1 on the basis of the pixel value candidates of the pixels of the leftmost column, the first row to the eighth row and the pixels of the uppermost row, the second column to the thirteenth column, which are included in the segment S1.

FIG. 8 is a conceptual diagram illustrating another example of the segment and the pixel value candidates according to the present embodiment.

In FIG. 8, the block mb1 indicates a to-be-processed block. Pixels in a shaded portion spreading from the upper right to the left center of the block mb1 indicate a segment S2. Arrows directed to the individual pixels of the leftmost column and the uppermost row of the block mb1 indicate that pixel value candidates for these pixels have been set. Here, the intra-plane prediction unit 106 sets the representative value of the segment S2 on the basis of the pixel value candidates of the pixels of the leftmost column, the ninth row to the twelfth row and the pixels of the uppermost row, the thirteenth column to the fifteenth column, which are included in the segment S2.

Next, in the case where a segment indicating the input segment information does not include pixel value candidates, the intra-plane prediction unit 106 sets the depth values of pixels included in that segment on the basis of a pixel value candidate for the pixel in the upper right-hand corner of the to-be-processed block (hereinafter referred to as the pixel in the upper right-hand corner) or a pixel value candidate for the pixel in the lower left-hand corner of the block (hereinafter referred to as the pixel in the lower left-hand corner), or on the basis of both the pixel in the upper right-hand corner and the pixel in the lower left-hand corner.

For example, the intra-plane prediction unit 106 sets each of the depth values of pixels included in the segment to the pixel value candidate for the upper right-hand corner pixel or the pixel value candidate for the lower left-hand corner pixel. Alternatively, the intra-plane prediction unit 106 may set that each of the depth values of pixels included in the segment is the average value of the pixel value candidate for the upper right-hand corner pixel and the pixel value candidate for the lower left-hand corner pixel. Alternatively, the intra-plane prediction unit 106 may set, as each of the depth values of pixels included in the segment, a value obtained by performing linear interpolation of the pixel value candidates for the upper right-hand corner pixel and the lower left-hand corner pixel with respective weight coefficients in accordance with the pixels included in the segment and the distances from the upper right-hand corner pixel and the lower left-hand corner pixel.

In this manner, the intra-plane prediction unit 106 sets the depth values of pixels included in each segment and generates an intra-plane-predicted image block representing the set depth values of the individual pixels.

Note that, in the case where the to-be-coded distance image block is positioned in the leftmost column of a frame, there is no coded reference image block adjacent to the left of the distance image block in the same frame. In addition, in the case where the to-be-coded distance image block is positioned on the uppermost row of a frame, there is no coded reference image block adjacent to the top of the distance image block in the same frame. In such cases, if there is a coded reference image block in the same frame, the intra-plane prediction unit 106 uses the depth values of pixels included in that block.

For example, in the case where the to-be-coded distance image block is positioned on the uppermost row of a frame, the intra-plane prediction unit 106 uses, as the distance values of pixels in the second column to the sixteenth column of the uppermost row of the block, the distance values of pixels in the second row to the sixteenth row of the rightmost column of the reference image block adjacent to the left of the distance image block. In addition, in the case where the to-be-coded distance image block is positioned in the leftmost column of a frame, the intra-plane prediction unit 106 uses, as the distance values of pixels on the second row to the sixteenth row of the leftmost column of the block, the distance values of pixels in the second column to the sixteenth column of the lowermost row of the reference image block adjacent to the top of the distance image block.

Referring back to FIG. 2, the intra-plane prediction unit 106 outputs the generated intra-plane-predicted image block to the coding control unit 107 and the switch 108.

Note that, in the case where the to-be-coded distance image block is positioned in the upper left-hand corner of a frame, the intra-plane prediction unit 106 cannot perform intra-plane prediction processing since there is no reference image block in the same frame. Thus, in such a case, the intra-plane prediction unit 106 does not perform intra-frame prediction processing.

The coding control unit 107 receives, as an input, the distance image block from the distance image input unit 100. The coding control unit 107 receives, as inputs, the weighted-predicted image block from the weighted prediction unit 104 and the intra-plane-predicted block from the intra-plane prediction unit 106.

The coding control unit 107 calculates a weighted prediction residual signal on the basis of the extracted distance image block and the input weighted-predicted image block. The coding control unit 107 calculates an intra-plane prediction residual signal on the basis of the extracted distance image block and the input intra-plane-predicted image block.

The coding control unit 107 determines, on the basis of the magnitude of the calculated weighted prediction residual signal and the magnitude of the calculated intra-plane prediction residual signal, a prediction scheme of, for example, a smaller prediction residual signal (weighted prediction or intra-plane prediction). The coding control unit 107 outputs a prediction scheme signal indicating the determined prediction scheme to the switch 108 and the variable length coding unit 115.

Alternatively, the coding control unit 107 may determine a prediction scheme with the minimum cost calculated using an available cost function for each prediction scheme. Here, the coding control unit 107 calculates the amount of information of the weighted prediction residual signal on the basis of the weighted prediction residual signal, and calculates the weighted prediction cost on the basis of the weighted prediction residual signal and the amount of information thereof. Also, the coding control unit 107 calculates the amount of information of the intra-plane prediction residual signal on the basis of the intra-plane prediction residual signal, and calculates the weighted prediction cost on the basis of the weighted prediction residual signal and the amount of information thereof.

In addition, the coding control unit 107 may assign the above-described intra-plane prediction as the signal value of the prediction scheme signal indicating one of existing intra-plane prediction modes (such as the DC mode or the Plane mode).

In the case where the to-be-coded distance image block is positioned in the upper left-hand corner of a frame, the intra-plane prediction unit 106 does not perform intra-plane prediction processing. Therefore, the coding control unit 107 determines the prediction scheme as weighted prediction, and outputs the prediction scheme signal indicating weighted prediction to the switch 108 and the variable length coding unit 115.

The switch 108 has two contacts a and b. The switch 108 receives, as an input, the weighted-predicted image block from the weighted prediction unit 104 when a variable segment is pushed down to the contact a, and receives, as an input, the intra-plane-predicted image block from the intra-plane prediction unit 106 when the variable segment is pushed down to the contact b; and the switch 108 receives, as an input, the prediction scheme signal from the coding control unit 107. On the basis of the input prediction scheme signal, the switch 108 outputs, as a predicted image block, one of the input weighted-predicted image block and the input intra-plane-predicted image block to the subtractor 109 and the adder 114.

That is, in the case where the prediction scheme signal indicates weighted prediction, the switch 108 outputs the weighted-predicted image block as a predicted image block. In the case where the prediction scheme signal indicates intra-plane prediction, the switch 108 outputs the intra-plane-predicted image block as a predicted image block. Note that the switch 108 is controlled by the coding control unit 107.

The subtractor 109 generates a residual signal block by subtracting the distance values of pixels constituting the predicted image block, which is input from the switch 108, from the distance values of pixels constituting the distance image block, which is input from the distance image input unit 100. The subtractor 109 outputs the generated residual signal block to the DCT unit 110.

The DCT unit 110 converts the residual signal block into a frequency domain signal by performing two-dimensional DCT (Discrete Cosine Transform) of the signal values of pixels constituting the residual signal block. The DCT unit 110 outputs the converted frequency domain signal to the inverse DCT unit 113 and the variable length coding unit 115.

The inverse DCT unit 113 converts the frequency domain signal, input from the DCT unit 110, into a residual signal block by performing two-dimensional inverse DCT (Inverse Discrete Cosine Transform) of the frequency domain signal. The inverse DCT unit 113 outputs the converted residual signal block to the adder 114.

The adder 114 generates a reference signal block by adding the distance values of pixels constituting the predicted signal block, which is input from the switch 108, and the distance values of pixels constituting the residual signal block, which is input from the inverse DCT unit 113. The adder 114 outputs the generated reference signal block to the plane storage unit 102 and causes the reference signal block to be stored therein.

The variable length coding unit 115 receives, as inputs, the motion vector signal from the motion vector detection unit 101, the prediction scheme signal from the coding control unit 107, and the frequency domain signal from the DCT unit 110. The variable length coding unit 115 performs Hadamard transform of the input frequency domain signal to generate a converted signal, performs compression coding of the converted signal so as to have a smaller amount of information, and thus generates a compressed residual signal. As an example of compression coding, the variable length coding unit 115 performs entropy coding. The variable length coding unit 115 outputs the compressed residual signal, the input motion vector signal, and the input prediction scheme signal as distance image code to the outside of the image coding apparatus 1. When the prediction scheme is predetermined, the signal thereof may not necessarily be included in the distance image signal.

The texture image coding unit 121 receives, as an input, a texture image on a frame-by-frame basis from the outside of the image coding apparatus 1, and codes the texture image in units of blocks constituting each frame by using an available image coding method, such as a coding method described in the ITU-T H.264 standard. The texture image coding unit 121 outputs texture image code generated by coding to the outside of the image coding apparatus 1. The texture image coding unit 121 outputs a reference signal block generated in the course of coding as a decoded texture image block to the segmentation unit 105.

Next, an image coding process performed by the image coding apparatus 1 according to the present embodiment will be described.

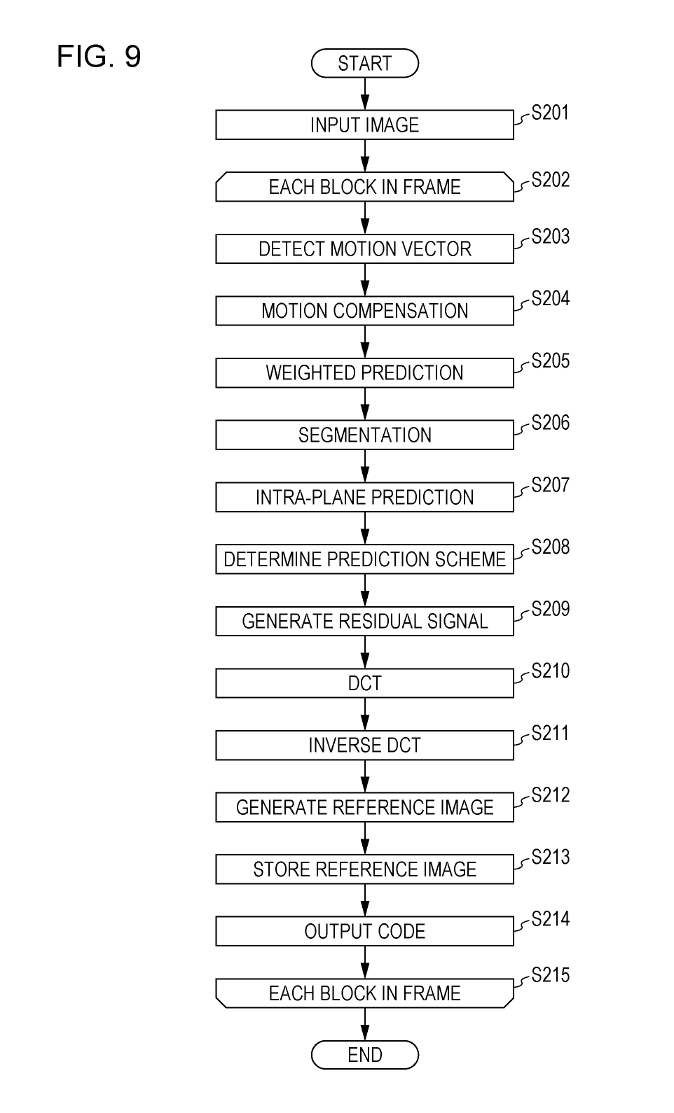

FIG. 9 is a flowchart illustrating an image coding process performed by the image coding apparatus 1 according to the present embodiment.

(step S201) The distance image input unit 100 receives, as an input, a distance image on a frame-by-frame basis from the outside of the image coding apparatus 1, and extracts a distance image block from the input distance image. The distance image input unit 100 outputs the extracted distance image block to the motion vector detection unit 101, the coding control unit 107, and the subtractor 109.

The texture image coding unit 121 receives, as an input, a texture image on a frame-by-frame basis from the outside of the image coding apparatus 1, and codes the texture image in units of blocks constituting each frame by using an available image coding method. The texture image coding unit 121 outputs texture image code generated by coding to the outside of the image coding apparatus 1. The texture image coding unit 121 outputs a reference signal block generated in the course of coding as a decoded texture image block to the segmentation unit 105.

Thereafter, the process proceeds to step S202.

(step S202) For each block in the frame, step S203 to step S215 are executed.

(step S203) The motion vector detection unit 101 receives, as an input, a distance image block from the distance image input unit 100, and reads reference image blocks from the plane storage unit 102. The motion vector detection unit 101 determines, from among the read reference image blocks, a predetermined number of reference image blocks, including a reference image block with the minimum index value with the input distance image block and so forth. The motion vector detection unit 101 detects, as a motion vector, the difference between the coordinates of the determined reference image blocks and the coordinates of the input distance image block.

The motion vector detection unit 101 outputs a vector signal indicating the detected motion vector to the variable length coding unit 115, and outputs the read reference image blocks to the motion compensation unit 103. Thereafter, the process proceeds to step S204.

(step S204) The motion compensation unit 103 sets the position of each of the reference image blocks, input from the motion vector detection unit 101, to the position of the input distance image block. The motion compensation unit 103 outputs the reference image blocks whose positions have been set to the weighted prediction unit 104. Thereafter, the process proceeds to step S205.

(step S205) The weighted prediction unit 104 generates a weighted-predicted image block by multiplying each of the reference image blocks, input from the motion compensation unit 103, by a weight coefficient, and adding these reference image blocks. The weighted prediction unit 104 outputs the generated weighted-predicted image block to the coding control unit 107 and the switch 108. Thereafter, the process proceeds to step S206.

(step S206) The segmentation unit 105 receives, as an input, the decoded texture image block from the texture image coding unit 121. The segmentation unit 105 divides the decoded texture image block into segments, which are groups of pixels included in the decoded texture image block, on the basis of the luminance values of the individual pixels. The segmentation unit 105 outputs, to the intra-plane prediction unit 106, segment information indicating a segment to which pixels included in each block belong. The segmentation unit 105 performs the process illustrated in FIG. 3 as a process of dividing the decoded texture image block into segments. Thereafter, the process proceeds to step S207.

(step S207) The intra-plane prediction unit 106 receives, as an input, the segment information of each block from the segmentation unit 105, and reads reference image blocks from the plane storage unit 102.

The intra-plane prediction unit 106 performs intra-plane prediction on the basis of the input segment information and the read reference image blocks, and generates an intra-plane-predicted image block. The intra-plane prediction unit 106 outputs the generated intra-plane-predicted image block to the coding control unit 107 and the switch 108. Thereafter, the process proceeds to step S208.

(step S208) The coding control unit 107 receives, as an input, the distance image block from the distance image input unit 100. The coding control unit 107 receives, as inputs, the weighted-predicted image block from the weighted prediction unit 104 and the intra-plane-predicted block from the intra-plane prediction unit 106.

The coding control unit 107 calculates a weighted prediction residual signal on the basis of the extracted distance image block and the input weighted-predicted image block. The coding control unit 107 calculates an intra-plane prediction residual signal on the basis of the extracted distance image block and the input intra-plane-predicted image block.

The coding control unit 107 determines a prediction scheme on the basis of the magnitude of the calculated weighted prediction residual signal and the magnitude of the calculated intra-plane prediction residual signal. The coding control unit 107 outputs a prediction scheme signal indicating the determined prediction scheme to the switch 108 and the variable length coding unit 115.

The switch 108 receives, as inputs, the weighted-predicted image block from the weighted prediction unit 104, the intra-plane-predicted image block from the intra-plane prediction unit 106, and the prediction scheme signal from the coding control unit 107. On the basis of the input prediction scheme signal, the switch 108 outputs one of the input weighted-predicted image signal and the input intra-plane-predicted image block as a predicted image block to the subtractor 109 and the adder 114. Thereafter, the process proceeds to step S209.

(step S209) The subtractor 109 generates a residual signal block by subtracting the distance values of pixels constituting the predicted image block, which is input from the switch 108, from the distance values of pixels constituting the distance image block, which is input from the distance image input unit 100. The subtractor 109 outputs the generated residual signal block to the DCT unit 110. Thereafter, the process proceeds to step S210.

(step S210) The DCT unit 110 converts the residual signal block into a frequency domain signal by performing two-dimensional DCT (Discrete Cosine Transform) of the signal values of pixels constituting the residual signal block. The DCT unit 110 outputs the converted frequency domain signal to the inverse DCT unit 113 and the variable length coding unit 115. Thereafter, the process proceeds to step S211.

(step S211) The inverse DCT unit 113 converts the frequency domain signal, input from the DCT unit 110, into a residual signal block by performing two-dimensional inverse DCT (Inverse Discrete Cosine Transform) of the frequency domain signal. The inverse DCT unit 113 outputs the converted residual signal block to the adder 114. Thereafter, the process proceeds to step S212.

(step S212) The adder 114 generates a reference signal block by adding the distance values of pixels constituting the predicted signal block, which is input from the switch 108, and the distance values of pixels constituting the residual signal block, which is input from the inverse DCT unit 113. The adder 114 outputs the generated reference signal block to the plane storage unit 102. Thereafter, the process proceeds to step S213.

(step S213) The plane storage unit 102 arranges and stores the reference image block, input from the adder 114, at the position of the block in the corresponding frame. Thereafter, the process proceeds to step S214.

(step S214) The variable length coding unit 115 performs Hadamard transform of the frequency domain signal, input from the DCT unit 110, to generate a converted signal, performs compression coding of the converted signal, and thus generates a compressed residual signal. The variable length coding unit 115 outputs, to the outside of the image coding apparatus 1, the generated compressed residual signal, the motion vector signal input from the motion vector detection unit 101, and the prediction scheme signal input from the coding control unit 107 as distance image code. Thereafter, the process proceeds to step S215.

(step S215) In the case where processing of all the blocks in the frame is not completed, the distance image input unit 100 shifts a distance image block to be extracted from the input distance image in the order of, for example, raster scan. Thereafter, the process returns to step S203. In the case where processing of all the blocks in the frame is completed, the distance image input unit 100 ends processing of that frame.

Next, the configuration and functions of an image decoding apparatus 2 according to the present invention will be described.

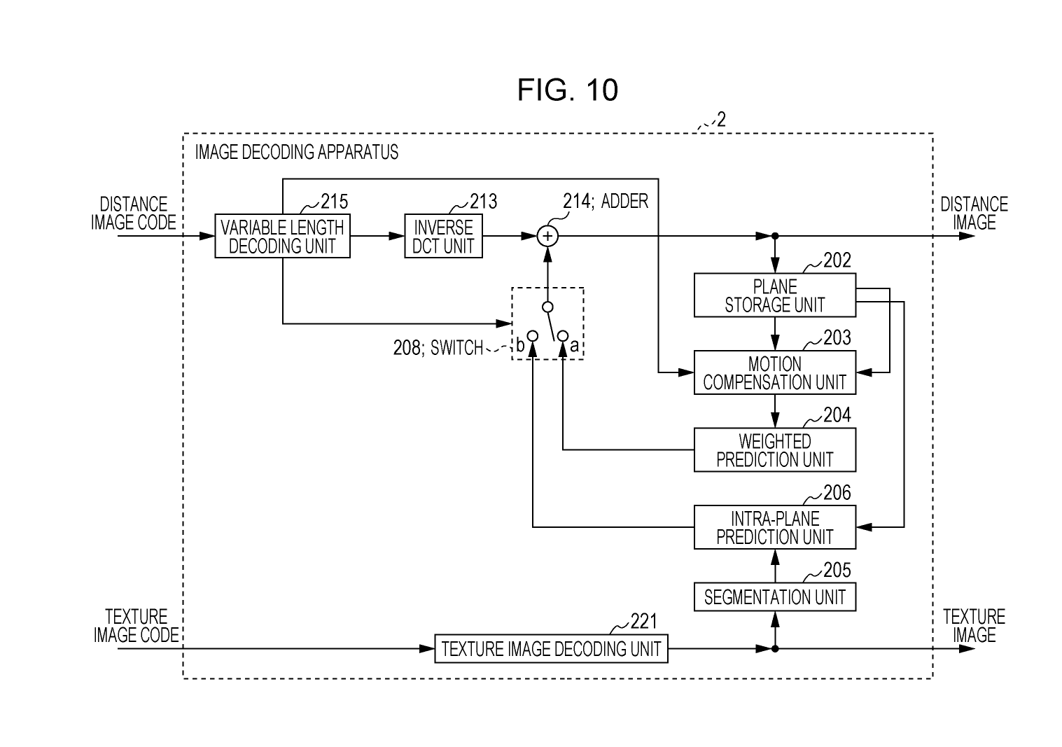

FIG. 10 is a schematic diagram illustrating the configuration of the image decoding apparatus 2 according to the present embodiment.

The image decoding apparatus 2 includes a plane storage unit 202, a motion compensation unit 203, a weighted prediction unit 204, a segmentation unit 205, an intra-plane prediction unit 206, a switch 208, an inverse DCT unit 213, an adder 214, a variable length decoding unit 215, and a texture image decoding unit 221.

The plane storage unit 202 arranges and stores a reference image block input from the adder 214 at the position of the block in a corresponding frame. Note that the plane storage unit 102 deletes reference images of past preset number of (such as six) frames.

The motion compensation unit 203 receives, as an input, a motion vector signal from the variable length decoding unit 215. The motion compensation unit 203 extracts, from the reference image stored in the plane storage unit 202, a reference image block with the coordinates indicated by the motion vector signal. The motion compensation unit 203 outputs the extracted reference image block to the weighted prediction unit 204.

The weighted prediction unit 204 generates a weighted-predicted image block by multiplying each of reference image blocks, input from the motion compensation unit 203, by a weight coefficient, and adding these reference image blocks. The weight coefficient may be a preset weight coefficient, or may be a pattern selected from among patterns of weight coefficients stored in advance in a code book. The weighted prediction unit 204 outputs the generated weighted-predicted image blocks to the switch 208.

The segmentation unit 205 receives, as an input, a decoded texture image block constituting a decoded texture image from the texture image decoding unit 221. The input decoded texture image block corresponds to distance image code input to the variable length decoding unit 215.

The segmentation unit 205 divides the decoded texture image block into segments, which are groups of pixels included in the decoded texture image block, on the basis of the luminance values of the individual pixels. Here, the segmentation unit 205 performs the process illustrated in FIG. 3 in order to divide the decoded texture image block into segments.

The segmentation unit 205 outputs, to the intra-plane prediction unit 206, segment information indicating a segment to which pixels included in each block belong.

The intra-plane prediction unit 206 receives, as an input, the segment information of each block from the segmentation unit 205, and reads reference image blocks from the plane storage unit 202. The reference image blocks read by the intra-plane prediction unit 206 are already decoded blocks and are blocks constituting a reference image of a frame serving as a current processing target. For example, the reference image blocks read by the intra-plane prediction unit 206 include a reference image block adjacent to the left of, and a reference image block adjacent to the top of a block serving as a current processing target.

On the basis of the input segment information and the read reference image blocks, the intra-plane prediction unit 206 performs intra-plane prediction and generates an intra-plane-predicted image block. A process of generating an intra-plane-predicted image block by the intra-plane prediction unit 206 may be the same as or similar to a process performed by the intra-plane prediction unit 106. The intra-plane prediction unit 206 outputs the generated intra-plane-predicted image block to the switch 208.

The switch 208 has two contacts a and b. The switch 208 receives, as an input, the weighted-predicted image block from the weighted prediction unit 204 when a variable segment is pushed down to the contact a, and receives, as an input, the intra-plane-predicted image block from the intra-plane prediction unit 206 when the variable segment is pushed down to the contact b; and the switch 208 receives, as an input, a prediction scheme signal from the variable length decoding unit 215. On the basis of the input prediction scheme signal, the switch 208 outputs, as a predicted image block, one of the input weighted-predicted image block and the input intra-plane-predicted image block to the adder 214.

That is, in the case where the prediction scheme signal indicates weighted prediction, the switch 208 outputs the weighted-predicted image block as a predicted image block. In the case where the prediction scheme signal indicates intra-plane prediction, the switch 208 outputs the intra-plane-predicted image block as a predicted image block.

The variable length decoding unit 215 receives, as an input, the distance image code from the outside of the image decoding apparatus 2, and extracts, from the input distance image code, the compressed residual signal indicating the residual signal, the vector signal indicating the motion vector, and the prediction scheme signal indicating the prediction scheme.

The variable length decoding unit 215 decodes the extracted compressed residual signal. This decoding scheme is an inverse process from compression coding performed by the variable length coding unit 115 and is a process of generating the original signal with a greater amount of information, such as entropy decoding. The variable length decoding unit 215 performs Hadamard transform of the signal, which is generated by decoding, to generate a frequency domain signal. This Hadamard transform is inverse transform of Hadamard transform performed by the variable length coding unit 115 and is a process of generating the original frequency domain signal.

The variable length decoding unit 215 outputs the generated frequency domain signal to the inverse DCT unit 213. The variable length decoding unit 215 outputs the extracted motion vector signal to the motion compensation unit 203, and outputs the extracted prediction scheme signal to the switch 208.

The inverse DCT unit 213 converts the frequency domain signal, input from the variable length decoding unit 215, into a residual signal block by performing two-dimensional inverse DCT of the frequency domain signal. The inverse DCT unit 213 outputs the converted residual signal block to the adder 214.

The adder 214 generates a reference signal block by adding the distance values of pixels constituting the predicted signal block, which is input from the switch 208, and the distance values of pixels constituting the residual signal block, which is input from the inverse DCT unit 213. The adder 214 outputs the generated reference signal block to the plane storage unit 202 and to the outside of the image decoding apparatus 2. The reference image block output to the outside of the image decoding apparatus 2 is a distance image block constituting a decoded distance image.

The texture image decoding unit 221 receives, as an input, texture image code on a block-by-block basis from the outside of the image decoding apparatus 2, decodes the texture image code on a block-by-block basis using a decoding method described in, for example, the ITU-T H.264 standard, and thus generates a decoded texture image block. The texture image decoding unit 221 outputs the generated decoded texture image block to the segmentation unit 205 and to the outside of the image decoding apparatus 2. The decoded texture image block output to the outside of the image decoding apparatus 2 is an image block constituting a decoded texture image.

Next, an image decoding process performed by the image decoding apparatus 2 according to the present embodiment will be described.

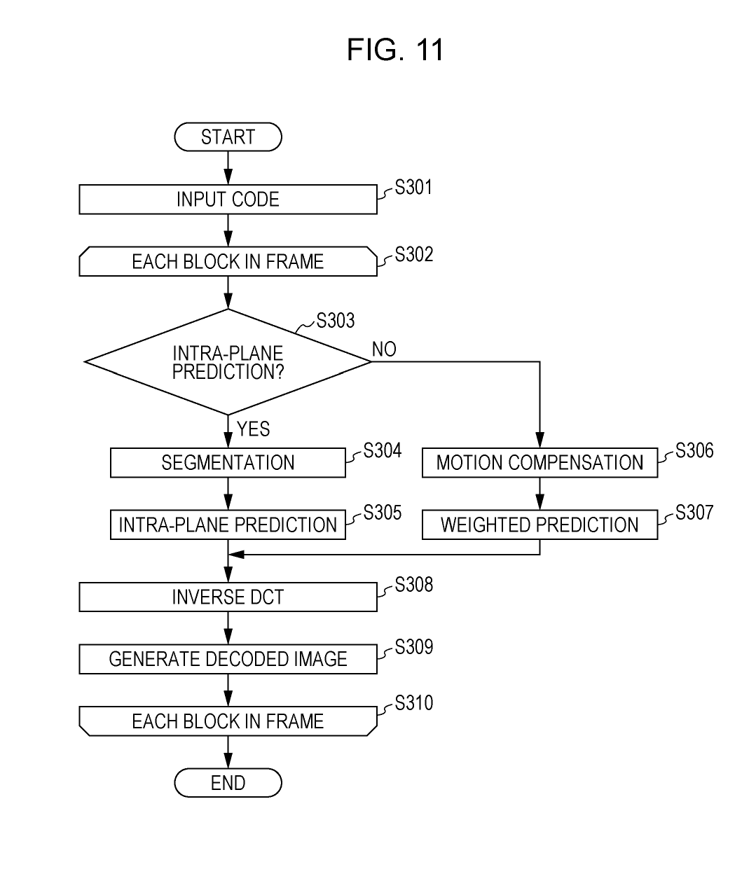

FIG. 11 is a flowchart illustrating an image decoding process performed by the image decoding apparatus 2 according to the present embodiment.

(step S301) The variable length decoding unit 215 receives, as an input, the distance image code from the outside of the image decoding apparatus 2, and extracts, from the input distance image code, the compressed residual signal indicating the residual signal, the vector signal indicating the motion vector, and the prediction scheme signal indicating the prediction scheme. The variable length decoding unit 215 decodes the extracted compressed residual signal, and performs Hadamard transform of the signal, which is generated by decoding, to generate a frequency domain signal. The variable length decoding unit 215 outputs the generated frequency domain signal to the inverse DCT unit 213. The variable length decoding unit 215 outputs the extracted motion vector signal to the motion compensation unit 203, and outputs the extracted prediction scheme signal to the switch 208.

The texture image decoding unit 221 receives, as an input, texture image code on a block-by-block basis from the outside of the image decoding apparatus 2, decodes the texture image code on a block-by-block basis using an available image decoding method, and thus generates a decoded texture image block. The texture image decoding unit 221 outputs the generated decoded texture image block to the segmentation unit 205 and to the outside of the image decoding apparatus 2. Thereafter, the process proceeds to step S302.

(step S302) For each block in the frame, step S303 to step S309 are executed.

(step S303) The switch 208 determines whether the prediction scheme signal, input from the variable length decoding unit 215, indicates intra-plane prediction or weighted prediction. In the case where the switch 208 determines that the prediction scheme signal indicates intra-plane prediction (step S303 Y), the process proceeds to step S304. In addition, the switch 208 outputs a weighted-predicted image block, generated in step S305 described later, as a predicted image block to the adder 214. In the case where the switch 208 determines that the prediction scheme signal indicates weighted prediction (step S303 N), the process proceeds to step S306. In addition, the switch 208 outputs an intra-plane-predicted image block, generated in step S307 described later, as a predicted image block to the adder 214.

(step S304) The segmentation unit 205 divides the decoded texture image block, which is input from the texture image decoding unit 221, into segments, which are groups of pixels included in the decoded texture image block, on the basis of the luminance values of the individual pixels. The segmentation unit 205 outputs, to the intra-plane prediction unit 206, segment information indicating a segment to which pixels included in each block belong. The segmentation unit 205 performs the process illustrated in FIG. 3 as a process of dividing the decoded texture image block into segments. Thereafter, the process proceeds to step S305.

(step S305) The intra-plane prediction unit 206 receives, as an input, the segment information of each block from the segmentation unit 205, and reads reference image blocks from the plane storage unit 202. The intra-plane prediction unit 206 performs intra-plane prediction on the basis of the input segment information and the read reference image blocks, and generates an intra-plane-predicted image block. A process of generating an intra-plane-predicted image block by the intra-plane prediction unit 206 may be the same as or similar to a process performed by the intra-plane prediction unit 106. The intra-plane prediction unit 206 outputs the generated intra-plane-predicted image block to the switch 208. Thereafter, the process proceeds to step S308.

(step S306) The motion compensation unit 203 extracts, from the reference image stored in the plane storage unit 202, a reference image block with the coordinates indicated by the motion vector signal input from the variable length decoding unit 215. The motion compensation unit 203 outputs the extracted reference image block to the weighted prediction unit 204. Thereafter, the process proceeds to step S307.

(step S307) The weighted prediction unit 204 generates a weighted-predicted image block by multiplying each of reference image blocks, input from the motion compensation unit 203, by a weight coefficient, and adding these reference image blocks. The weighted prediction unit 204 outputs the generated weighted-predicted image block to the switch 208. Thereafter, the process proceeds to step S308.

(step S308) The inverse DCT unit 213 converts the frequency domain signal, input from the variable length decoding unit 215, into a residual signal block by performing two-dimensional inverse DCT of the frequency domain signal. The inverse DCT unit 213 outputs the converted residual signal block to the adder 214. Thereafter, the process proceeds to step S309.

(step S309) The adder 214 generates a reference signal block by adding the distance values of pixels constituting the predicted signal block, which is input from the switch 208, and the distance values of pixels constituting the residual signal block, which is input from the inverse DCT unit 213. The adder 214 outputs the generated reference signal block to the plane storage unit 202 and to the outside of the image decoding apparatus 2. Thereafter, the process proceeds to step S310.

(step S310) In the case where processing of all the blocks in the frame is not completed, the variable length decoding unit 215 shifts a block of the input distance image code in the order of, for example, raster scan. Thereafter, the process returns to step S303.

In the case where processing of all the blocks in the frame is completed, the variable length decoding unit 215 ends processing of that frame.

In the above description, the size of the texture image block, distance image block, predicted image block, and reference image block are described as 16 pixels in the horizontal direction×16 pixels in the vertical direction. However, the size is not limited to this size in the present embodiment. The size may be any of, for example, 8 pixels in the horizontal direction×8 pixels in the vertical direction, 4 pixels in the horizontal direction×4 pixels in the vertical direction, 32 pixels in the horizontal direction×32 pixels in the vertical direction, 16 pixels in the horizontal direction×8 pixels in the vertical direction, 8 pixels in the horizontal direction×16 pixels in the vertical direction, 8 pixels in the horizontal direction×4 pixels in the vertical direction, 4 pixels in the horizontal direction×8 pixels in the vertical direction, 32 pixels in the horizontal direction×16 pixels in the vertical direction, and 16 pixels in the horizontal direction×32 pixels in the vertical direction.

As described above, according to the present embodiment, in the image coding apparatus which codes, on a block-by-block basis, a distance image including the depth values of individual pixels representing distances from the viewpoint to the subject, a block of a texture image including the luminance values of individual pixels of the subject is divided into segments including the pixels on the basis of the luminance values, the depth values of each of the divided segments included in one block of the distance image are set on the basis of the depth values of pixels included in an already-coded block adjacent to the foregoing block, and a predicted image including the set depth values of the individual segments is generated on a block-by-block basis.

In addition, according to the present embodiment, in the image decoding apparatus which decodes, on a block-by-block basis, a distance image including the depth values of individual pixels representing distances from the viewpoint to the subject, a segmentation unit that divides a block of a texture image including the luminance values of individual pixels of the subject into segments including the pixels on the basis of the luminance values, the depth values of each of the divided segments included in one block of the distance image are set on the basis of the depth values of pixels included in an already-decoded block adjacent to the foregoing block, and a predicted image including the set depth values of the individual segments is generated on a block-by-block basis.

Here, a portion representing the same subject in a texture image tends to have a relatively small spatial change in color. By taking into consideration the correlation between the texture image and a corresponding distance image, that portion also has a small spatial change in depth value. Thus, it is expected that depth values in segments obtained by dividing a to-be-processed block are the same on the basis of signal values indicating colors of individual pixels included in the texture image. Therefore, an intra-plane-predicted image block can be highly accurately generated since the present embodiment has the above-described configurations, and thus, the distance image can be coded or decoded.

Also, according to the present embodiment, the distance image block can be coded or decoded using the above-described intra-plane prediction scheme on the basis of the texture image block. To indicate this prediction scheme, the amount of information increases only by one bit in each block. Therefore, not only the distance image can be highly accurately coded or decoded by the present embodiment, but also an increase in the amount of information can be suppressed.

Note that part of the image coding apparatus 1 or the image decoding apparatus 2 in the above-described embodiment, such as the distance image input unit 100, the motion vector detection unit 101, the motion compensation units 103 and 203, the weighted prediction units 104 and 204, the segmentation units 105 and 205, the intra-plane prediction units 106 and 206, the coding control unit 107, the switches 108 and 208, the subtractor 109, the DCT unit 110, the inverse DCT units 113 and 213, the adders 114 and 214, the variable length coding unit 115, and the variable length decoding unit 215, may be realized with a computer. In this case, a program for realizing the control functions may be recorded on a computer-readable recording medium, and the image coding apparatus 1 or the image decoding apparatus 2 may be realized by causing a computer system to read and execute the program recorded on the recording medium. Note that the “computer system” referred to here is a computer system built into the image coding apparatus 1 or the image decoding apparatus 2, and it is assumed to include an OS and hardware such as peripheral devices. In addition, the “computer-readable recording medium” refers to a portable medium such as a flexible disk, a magneto-optical disc, ROM, CD-ROM, or the like, or a storage device such as a hard disk built into the computer system. Further, the “computer-readable recording medium” may also encompass media that briefly or dynamically retain the program, such as a communication line in the case where the program is transmitted via a network such as the Internet or a communication channel such as a telephone line, as well as media that retain the program for a given period of time, such as a volatile memory inside the computer system acting as a server or client in the above case. Moreover, the above-described program may be for realizing part of the functions discussed earlier, and may also realize the functions discussed earlier in combination with programs already recorded in the computer system.

In addition, part or all of the image coding apparatus 1 or the image decoding apparatus 2 in the above-described embodiment may also be typically realized as an integrated circuit such as an LSI (Large Scale Integration). The respective function blocks of the image coding apparatus 1 or the image decoding apparatus 2 may be realized as individual processors, or part or all thereof may be integrated into a single processor. Furthermore, the circuit integration methodology is not limited to LSI and may also be realized with dedicated circuits or general processors. In addition, if progress in semiconductor technology yields integrated circuit technology that may substitute for LSI, an integrated circuit according to that technology may also be used.

Although the embodiment of the invention has been described in detail with reference to the drawings, specific configurations are not limited to those described above, and various design changes and the like can be made within a scope that does not depart from the gist of the present invention.

### INDUSTRIAL APPLICABILITY

As has been described above, an image coding apparatus, an image coding method, an image coding program, an image decoding apparatus, an image decoding method, and an image decoding program according to the present invention are useful in compressing the amount of information of an image signal representing a three-dimensional image and are applicable to, for example, saving or transmission of image content.

### DESCRIPTION OF REFERENCE NUMERALS

1 image coding apparatus
2 image decoding apparatus
100 distance image input unit
101 motion vector detection unit
102, 202 plane storage units
103, 203 motion compensation units
104, 204 weighted prediction units
105, 205 segmentation units
106, 206 intra-plane prediction units
107 coding control unit
108, 208 switches
109 subtractor, 110 DCT unit
113, 213 inverse DCT units
114, 214 adders
115 variable length coding unit
121 texture image coding unit
215 variable length decoding unit
221 texture image decoding unit

1-20. (canceled)

21. An image coding apparatus that codes, on a block-by-block basis, a distance image including depth values of pixel, comprising:
a segmentation unit that divides the block into segments on the basis of luminance values of individual pixels included in a decoded texture image block which corresponds to the distance image, and generates segment information indicating a segment to which pixels included in each block belong; and
an intra-plane prediction unit that predicts depth values of each block on the basis of the segment information and depth values of pixels of an adjacent block.

22. The image coding apparatus according to claim 21,
wherein the intra-plane prediction unit predicts the depth values of each block on the basis of depth values of pixels included in a block adjacent to the left of, and a block adjacent to the top of a block including the segment.

23. An image decoding apparatus that decodes, on a block-by-block basis, a distance image including depth values of pixels, comprising:
a segmentation unit that divides the block into segments on the basis of luminance values of individual pixels included in a decoded texture image block which corresponds to the distance image, and generating segment information indicating a segment to which pixels included in each block belong; and
an intra-plane prediction unit that predicts depth values of each block on the basis of the segment information and depth values of pixels of an adjacent block.

24. The image decoding apparatus according to claim 23,
wherein the intra-plane prediction unit predicts depth values of block on the basis of depth values of pixels included in a block adjacent to the left of, and a block adjacent to the top of a block including the segment.

25. An image decoding method of an image decoding apparatus that decodes, on a block-by-block basis, a distance image including depth values of pixels, comprising:
a first process of dividing, in the image decoding apparatus, the block into segments on the basis of luminance values of individual pixels included in a decoded texture image block which corresponds to the distance image, and generating segment information indicating a segment to which pixels included in each block belong; and
a second process of predicting, in the image decoding apparatus, depth values of each block on the basis of the segment information and depth values of pixels of an adjacent block.
